(19) United States
(12) Patent Application Publication
(10) Pub. No.: US 2003/0071904 A1
(43) Pub. Date: Apr. 17, 2003

(54) Image capturing apparatus, image reproducing apparatus and program product

(75) Inventors: Toshihiko Karasaki, Kawachinagano-Shi (JP); Noriyuki Okisu, Osakasayama-Shi (JP); Masahito Niikawa, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO. , LTD

(21) Appl. No.: 10/270,874

(22) Filed: Oct. 14, 2002

(30) Foreign Application Priority Data
Oct. 16, 2001 (JP) P2001-318047

(51) Int. Cl. H04N 5/222

(52) U.S. Cl. 348/231.3; 348/333.12; 348/240.2

(57) ABSTRACT

In a digital camera, an AF position can be designated by an AF cursor which is displayed on a liquid crystal display (LCD) and moves according to an operation input by the operator. At the time of recording captured image data into a memory card, information of the AF position in a whole image and an enlargement display magnification which is separately set is recorded in association with the image data. Thus, at the time of reproducing the recorded image, based on the information of the AF position and the enlargement display magnification in the memory card, desired enlargement display around the AF position as a center can be performed. As a result, convenience of the digital camera is improved.

This application is based on application No. 2001-318047 filed in Japan, the contents of which are hereby incorporated by reference.

### BACKGROUND OF THE INVENTION

1. Field of the Invention

The present invention relates to a technique of a digital camera for designating a designation position by a pointer which moves according to an operation input.

2. Description of the Background Art

In a digital camera, in recent years, the number of pixels of an image pickup device is increasing to address a request of higher picture quality whereas increase in the number of pixels of a camera display part such as a view finder cannot be expected as much as the image pickup device due to limitation of the size of the camera. In the display part, there are consequently cases that it is difficult to recognize the details of a captured image.

Japanese Unexamined Patent Publication No. 11-196301 discloses a technique of designating a position in a subject image in a digital camera and enlargedly displaying an image around the designated position as a center on a display unit. By the technique, the details of a result of image pickup such as closed eyes, out of focus, and blurring at the time of image pickup can be recognized.

However, in the digital camera, the details regarding the designation of a designation position are not clear and association between the designation position and an image at the time of recording is not considered at all. Consequently, besides the case where position designation data remains in a memory such as a RAM in the digital camera, in the case where an image pickup mode is switched to a reproduction mode, the case where the power source is turned off once and the like, the position designation data disappears from the memory. As a result, when the operator wishes to enlargedly display an image on the basis of the position designation data at the time of reproducing an image recorded on a memory card or the like, since a position reference of enlarging display is unknown, the enlarging display intended by the operator cannot be performed and it is inconvenient.

### SUMMARY OF THE INVENTION

The present invention is directed to an image capturing apparatus.

According to the present invention, the image capturing apparatus includes: an image sensor for capturing an image of a subject and generating image data; a display for displaying an image based on the image data generated by the image sensor onto a screen; a designating member for designating a specific position in the image displayed on the screen; and a recorder for recording the image data and information of the specific position designated by the designating member so as to be associated with each other on a nonvolatile memory. Consequently, convenience can be improved in reproduction of a recorded image.

In a preferred embodiment of the present invention, the image capturing apparatus further includes a display controller for enlarging an image in a predetermined area including the specific position designated by the designating member and displaying an enlarged image onto the display. Consequently, enlargement display in which the intended specific position is reflected can be performed.

The present invention is also directed to an image reproducing apparatus capable of reproducing image data in a nonvolatile memory, and a program product on which a program that can be read by an image processing apparatus is recorded.

An object of the present invention is therefore to provide a technique of improving convenience in reproduction of a recorded image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a digital camera according to an embodiment of the present invention;

FIG. 2 is a rear view of the digital camera;

FIG. 3 is a side view of the digital camera;

FIG. 4 is a bottom view of the digital camera;

FIG. 5 is a block diagram showing an internal configuration of the digital camera;

FIG. 6 is a block diagram showing a configuration of an image processing unit;

FIG. 7 is a diagram for describing live view display;

FIG. 8 is a partial block diagram of the digital camera;

FIG. 9 is a diagram for describing an AF cursor CR displayed on an LCD;

FIG. 10 is a diagram for describing photometry in the digital camera;

FIG. 11 is a diagram showing a data sequence of a memory card;

FIG. 12 is a diagram showing contents of tag information;

FIG. 13 is a diagram showing a screen for setting an enlarging display magnification;

FIG. 14 is a flowchart for describing an operation in an image pickup mode of the digital camera;

FIG. 15 is a flowchart for describing operation in the image pickup mode of the digital camera;

FIG. 16 is a diagram showing an after view setting screen;

FIGS. 17A and 17B are diagram for describing switching of a display magnification of an image;

FIG. 18 is a state transition diagram showing an operation in a reproduction mode of the digital camera;

FIG. 19 is a diagram for describing multi-display;

FIG. 20 is a diagram for describing a process in the case where an enlarged area lies off a whole image;

FIG. 21 is a schematic diagram showing a configuration of a main portion of a personal computer;

FIG. 22 is a functional block diagram of the personal computer;

FIG. 23 is a flowchart for describing an image reproducing operation in the personal computer; and

FIG. 24 is a diagram showing a window screen displayed by activating a reproduction program.

### DESCRIPTION OF THE PREFERRED EMBODIMENTS

Configuration of Main Portion of Digital Camera

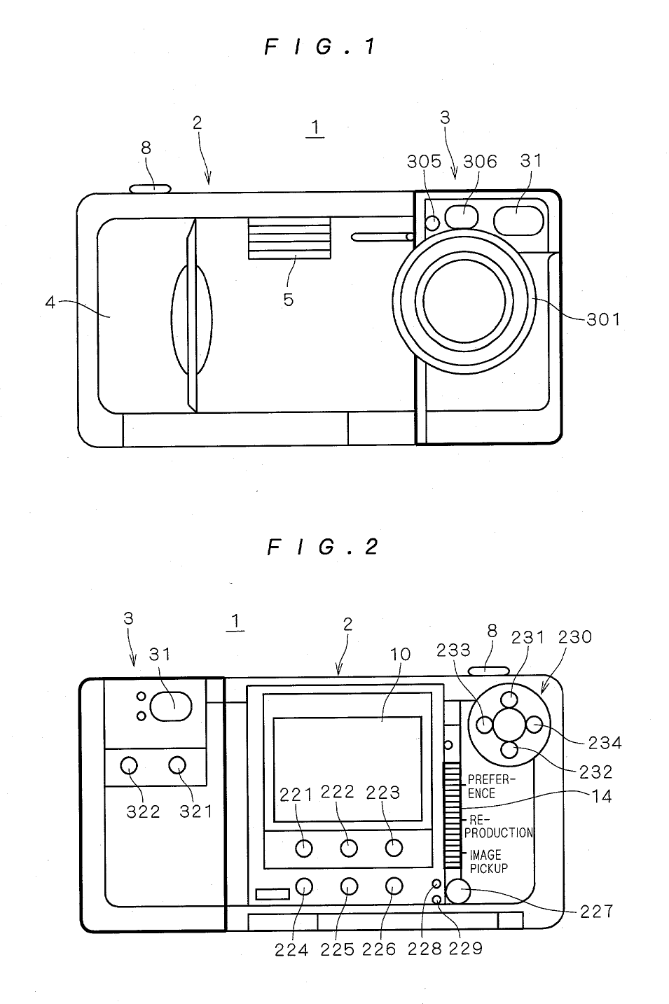

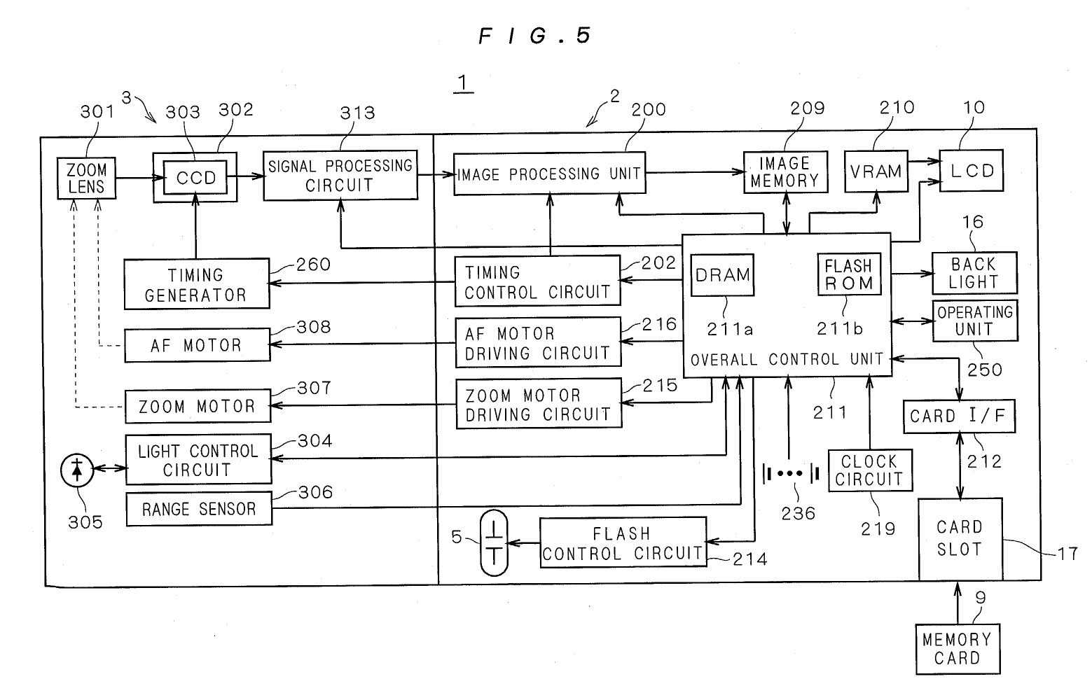

FIGS. 1 to 4 are a front view, a rear view, a side view and a bottom view of a digital camera 1 according to an embodiment of the present invention. FIG. 5 is a block diagram showing an internal configuration of the digital camera 1.

The digital camera 1 is constructed by, as shown in FIG. 1, a box-shaped camera body part 2 and an image pickup part 3 of a rectangular parallelepiped shape (indicated by thick lines in FIGS. 1, 2 and 4). The image pickup part 3 has a zoom lens 301 with a macro function as an imaging lens and, in a manner similar to a lens shutter camera using a silver halide film (hereinafter, referred to as a “silver-film camera”), a light control sensor 305 for receiving reflected light of flash light from a subject, and an optical finder 31. The zoom lens 301 can zoom in and out on a subject in a range of focal distance from 35 mm to 70 mm in terms of a silver-film camera using a 35 mm film.

The image pickup part 3 has therein a CCD 303 (see FIG. 5) as a CCD color area sensor functioning as image sensor in a position rearward of the zoom lens 301, and the CCD 303 is a part of an image pickup circuit 302.

As shown in FIG. 1, in the front face of the camera body part 2, a grip part 4 is provided at the left end, a built-in flash 5 is provided in the center of the upper part, and a shutter button 8 is provided on the top face.

As shown in FIG. 2, in the rear face of the camera body 2, an LCD 10 for displaying a captured image (corresponding to a view finder) and reproducing and displaying a recorded image is provided almost in the center. The LCD 10 has a display screen of 400×300 pixels. Below the LCD 10, a group of key switches 221 to 226 for performing operations on the digital camera 1 and a power supply switch 227 are provided. The key switch 221 functions as a deletion button for deleting a captured image in the image pickup mode. The key switch 222 functions as a slide show start button for starting a slide show which sequentially displays a plurality of captured images. The key switch 223 functions as a multi-display button for simultaneously displaying a plurality of images, for example, four images. The key switch 224 functions as a display magnification switch button for switching a display magnification of an image displayed on the LCD. The key switch 225 functions as an AF cursor button for displaying an AF cursor CR corresponding to a focus position on the LCD 10. The key switch 226 functions as a menu button. On the left side of the power supply switch 227, an LED 228 which is turned on when the power source is turned on, and an LED 229 indicating that a memory card is being accessed are disposed.

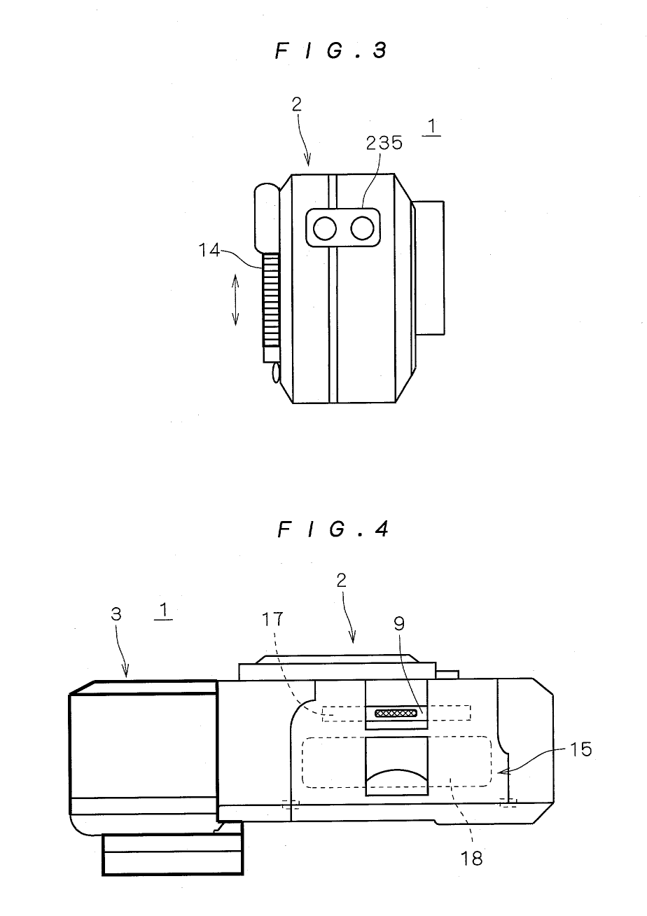

On the rear face of the camera body 2, a mode setting switch 14 for switching a mode among an “image pickup mode”, a “reproduction mode”, and a “preference mode” is provided (see FIG. 3). The image pickup mode is a mode of taking a picture. The reproduction mode is a mode of reproducing a captured image recorded in the memory card 9 and displaying the image to the LCD 10. Further, the preference mode is a mode of making various settings by selecting one of display items (setting items).

The mode setting switch 14 is a slide switch of three contacts. In FIG. 2, when the mode setting switch 14 is set to the low, the image pickup mode is set. When the mode setting switch 14 is set to the center, the reproduction mode is set. When the mode setting switch 14 is set to the up, the preference mode is set.

On the right side of the rear face of the camera, a four-way switch 230 is provided. By depressing buttons 231 and 232, zooming of changing the focal distance of the zoom lens 301 is performed. By depressing buttons 233 and 234, exposure correction can be manually performed.

On the rear face of the image pickup part 3, as shown in FIG. 2, an LCD button 321 for turning on/off the LCD 10 and a macro button 322 are provided. When the LCD button 321 is depressed, the on/off state of the LCD display is switched. For example, in the case of capturing an image only by using the optical finder 31, the LCD display is turned off to save power. At the time of macro image pickup, by depressing the macro button 322, the AF motor 308 (see FIG. 5) is driven and the zoom lens 301 can perform macro image pickup.

On a side face of the camera body 2, a DC input terminal 235 is provided as shown in FIG. 3.

In the bottom face of the camera body 2, as shown in FIG. 4, a battery loading room 18 and a card loading room 17 (card slot) are provided. The memory card 9 can be loaded in the card loading room 17. The card loading room 17 can be closed by a clamshell-type cover 15.

In the digital camera 1, by loading four AA cells to the battery loading room 18, a power supply battery 236 (see FIG. 5) obtained by connecting the four AA cells in series is used as a drive source. Obviously, the power from an adapter can be supplied from the DC input terminal shown in FIG. 3.

The internal configuration of the image pickup part 3 will now be described with reference to FIG. 5.

The image pickup circuit 302 photoelectrically converts an optical image of a subject formed on the CCD 303 by the zoom lens 301 by using the CCD 303, and outputs the resultant as image data (signals including signal trains of pixel signals received by pixels) of color components of R (red), G (green) and B (blue). The CCD 303 has 1600×1200 pixels.

Since the stop of the digital camera 1 is a fixed stop, exposure control in the image pickup part 3 is performed by adjusting an exposure amount of the CCD 303 (charge accumulation time of the CCD 303 corresponding to a shutter speed). When the brightness of the subject is low and a proper shutter speed cannot be set, improper exposure due to insufficient exposure is corrected by adjusting the level of an image signal outputted from the CCD 303. More specifically, at the time of low brightness, exposure control is performed by combining the shutter speed and gain adjustment. The level of the image signal is adjusted by an AGC (Auto Gain Control) circuit in a signal processing circuit 313 which will be described later. Photometry in the automatic exposure (AE) will be described in detail later.

A timing generator 250 generates a drive control signal of the CCD 303 synchronously with a clock transmitted from a timing control circuit 202 in the camera body part 2. The timing generator 250 generates, for example, timing signals of start and end of integration (that is, start and end of exposure) and clock signals such as read control signals (horizontal sync signal, a vertical sync signal, a transfer signal and the like) of light reception signals of pixels and outputs the signals to the CCD 303.

The signal processing circuit 313 performs a predetermined analog signal process on an image signal (analog signal) outputted from the image pickup circuit 302. The signal processing circuit 313 has therein, although not shown, a CDS (Correlated Double Sampling) circuit and an AGC circuit. Noise of an image signal is reduced by the CDS circuit and the gain of the AGC circuit is adjusted, thereby adjusting the level of an image signal.

The light control circuit 304 controls the light emission amount of the built-in flash 5 in image pickup with a flash to a predetermined light emission amount set by an overall control unit 211 in the camera body unit 2. In image pickup with a flash, reflection light of flash light from the subject is received by the light control sensor 305 simultaneously with start of exposure. When the received light amount reaches a predetermined light emission amount, a flash stop signal is outputted from the light control circuit 304 to the flash control circuit 214 in the camera body 2 via the overall control unit 211. In response to the flash stop signal, the flash control circuit 214 forcedly stops flash of the built-in flash 5, and the light emission amount of the built-in flash 5 is controlled to the predetermined light emission amount.

The image pickup part 3 has therein a zoom motor 307 for changing a zoom ratio of the zoom lens 301 and moving the lens between a housing position and an image pickup position, and an AF (auto focus) motor 308 for achieving a focus.

The internal configuration of the camera body 2 will now be described.

The overall control unit 211 is constructed mainly by a CPU and controls an image capturing operation of the digital camera 1 by controlling driving of peripheral devices in the image pickup part 3 and the camera body part 2 connected via an address bus, a data bus and a control bus.

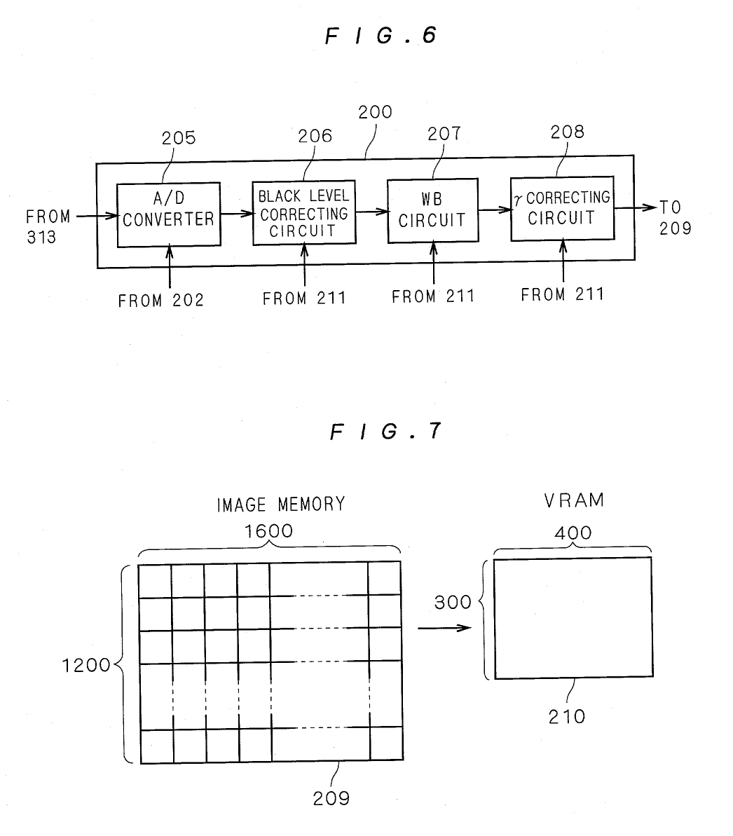

The flow of image data in FIG. 5 (and FIG. 6 which will be described later) is indicated by arrows connecting the peripheral devices for convenience. In practice, image data is transmitted to each peripheral device via the overall control unit 211. The overall control unit 211 has therein a work RAM 211a taking the form of a DRAM and a flash ROM 211b for storing a program.

The process of an image signal and the configuration related to image display in the camera body part 2 will now be described.

An analog image signal sent from the signal processing circuit 313 of the image pickup part 3 is subjected to various image processes in an image processing unit 200 in the camera body 2. FIG. 6 is a block diagram showing the configuration of the image processing unit 200. First, the analog image signal transmitted to the image processing unit 200 is converted to a digital signal of 10 bits per pixel in an A/D converter 205. The A/D converter 205 converts each pixel signal (analog signal) to a digital signal of 10 bits on the basis of a clock for A/D conversion inputted from the timing control circuit 202.

The timing control circuit 202 generates a reference clock and clocks for the timing generator 250 and the A/D converter 205 under control of the overall control unit 211.

A black level correcting circuit 206 corrects the black level of an A/D converted pixel signal (hereinafter, referred to as “pixel data”) to a reference black level. A WB circuit 207 performs level shifting of pixel data of each of color components of R, G and B, and executes automatic white balance adjustment (AWB) in consideration of γ correction in a post process. The white balance is adjusted by using a level shifting table (to be accurate, data of the table) inputted from the overall control unit 211 to the WB circuit 207. A color component shift coefficient (gradient of characteristic) of the level shifting table is set for each captured image by the overall control unit 211.

A γ correcting circuit 208 corrects the γ characteristic of the pixel data. An output from the γ correcting circuit 208 is sent to an image memory 209 as shown in FIG. 5.

The image memory 209 is a memory for storing pixel data outputted from the image processing unit 200 and has a storage capacity of one frame. More specifically, when the CCD 303 has 1600×1200 pixels arranged in a matrix, the image memory 209 has a storage capacity of pixel data of 1600×1200 pixels, and each pixel data is stored in a corresponding storage area (address).

A VRAM 210 is a buffer memory of image data displayed on the LCD 10. The VRAM 210 has a storage capacity of image data corresponding to 400×300 pixels of the LCD 10, that is, a capacity of 400×300 pixels.

With such a configuration, in an image pick standby mode in the image pickup mode, each of pixel data of an image captured every predetermined interval by the image pickup part 3 is processed by the image processing unit 200, stored in the image memory 209, transferred to the VRAM 210 via the overall control unit 211, and displayed on the LCD 10. In such a manner, live view display of displaying an image of a subject before image pickup like moving images on the LCD 10 can be performed. The image pickup standby mode denotes a state before the shutter button 8 is touched (S1).

More specifically, in the live view display, as shown in FIG. 7, image data in the image memory 209 of 1600×1200 pixels is reduced to 1/4 in each of the vertical and horizontal directions and the resultant image data is transferred to the VRAM 210 of 400×300 pixels.

In the reproduction mode, the image read from the memory card 9 is subjected to a predetermined signal process by the overall control unit 211 and, after that, the resultant image is transferred to the VRAM 210 and reproduced and displayed on the LCD 10. At the time of displaying an image on the LCD 10, a back light 16 is turned on by the control of the overall control unit 211.

The other internal configuration of the camera body part 2 will now be described.

A card I/F 212 is an interface for transmitting/receiving a signal to/from the memory card 9 loaded in the card loading room 17. Concretely, the card I/F 212 writes/reads image data to/from the memory card 9.

A flash control circuit 214 is a circuit for controlling light emission of the built-in flash 5 as described above. The flash control circuit 214 controls light emission, a light emission amount, a light emission timing and the like of the built-in flash 5 on the basis of a control signal of the overall control unit 211, and controls the light emission amount of the built-in flash 5 on the basis of a flash stop signal inputted from a light control circuit 304.

A clock circuit 219 is used to manage date and time of image pickup and driven by not-shown another power source.

The camera body 2 has also therein a zoom motor driving circuit 215 and an AF motor driving circuit 216 for driving the zoom motor 307 and the AF motor 308. The circuits function in accordance with an operation of an operating unit 250 constructed by the shutter button 8 and the above-described various switches and buttons.

The shutter button 8 is a two-stage switch capable of detecting the touched state (S1) and the depressed state (S2). When the shutter button 8 is touched in the image pickup standby mode, the AF motor driving circuit 216 drives the AF motor 308 to move the zoom lens 301 to a position where focus is achieved.

When the buttons 231 and 232 are depressed, signals from the buttons are sent to the overall control unit 211. In accordance with an instruction of the overall control unit 211, the zoom motor driving circuit 215 drives the zoom motor 307 to move the zoom lens, thereby performing optical zooming.

The components in the camera body 2 have been described above. The overall control unit 211 performs various functions by software other than transmission/reception of data to/from the peripheral devices and timing control.

For example, the overall control unit 211 has a brightness determining function and a shutter speed setting function of setting an exposure control value (shutter speed). The brightness determining function is to determine the brightness of the subject by using an image captured by the CCD 303 every 1/30 second and stored in the image memory 209 in the image pickup standby mode. The shutter speed setting function is to set a shutter speed (integration time of the CCD 303) on the basis of a result of determination of the brightness of the subject by determination of brightness.

To perform a process of recording a captured image, the overall control unit 211 has a filtering process function, a recording image generating function and, further, a reproduction image generating function.

The filtering process function is to correct high frequency components of an image to be recorded by a digital filter, thereby correcting picture quality regarding an outline.

The recording image generating function is to read pixel data from the image memory 209 and generate a thumbnail image and a compressed image to be recorded on the memory card 9. Concretely, while scanning pixel data in the image memory 209 in a raster scan direction, pixel data is read every 8 pixels in each of the horizontal and vertical directions, and sequentially transferred to the memory card 9, thereby recording the pixel data onto the memory card 9 while generating a thumbnail image. At the time of recording the compressed image data to the memory card 9, all of the pixel data is read from the image memory 209, subjected to two-dimensional DCT, and a predetermined compressing process according to the JPEG method such as Huffman coding, and-the resultant is recorded onto the memory card 9.

As a concrete operation, in the image pickup mode, when image pickup is instructed by the shutter button 8, a thumbnail image of an image stored in the image memory 209 after the instruction of image pickup and an image compressed according to the JPEG system at a set compression ratio are generated and stored into the memory card 9 together with tag information (information such as frame number, exposure value, shutter speed, compression ratio, date of image pickup, data of the on/off state of flash at the time of image pickup, scene information, and a result of determination of an image). A recording format of image data to the memory card 9 will be described in detail later.

The reproduction image generating function is a function of generating a reproduction image by decompressing the compressed image recorded on the memory card 9. As a concrete operation, when the mode setting switch 14 is set in the reproduction mode, image data of the largest frame number in the memory card is read and decompressed, and the resultant data is transferred to the VRAM 210. Consequently, on the LCD 10, an image of the largest frame number, that is, an image captured latest is displayed.

Regarding AF

The digital camera 1 has the image pickup mode in which an AF cursor CR for designating an automatic focus (AF) position on the LCD 10, which will be described later.

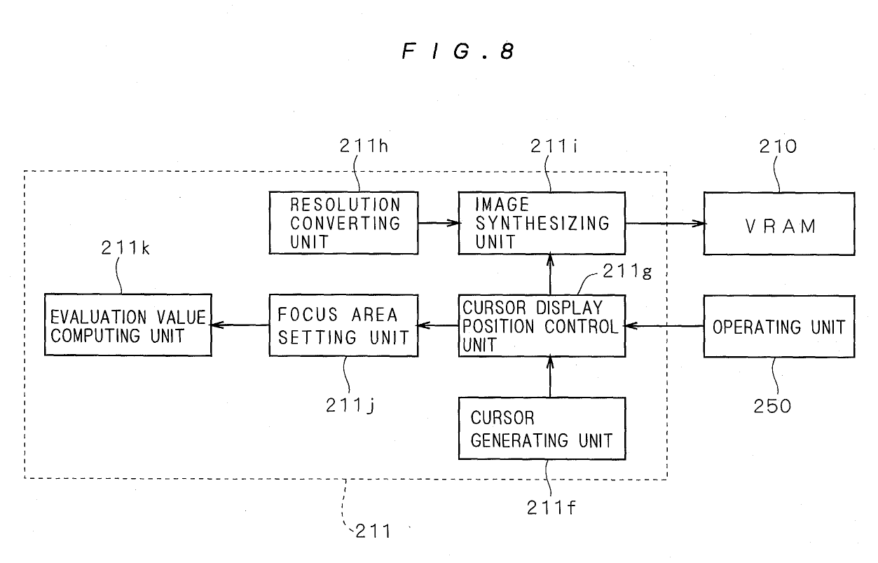

FIG. 8 is a partial block diagram of the digital camera 1.

The overall control unit 211 has a cursor generating unit 211f, a cursor display position control unit 211g, a resolution converting unit 211h, an image synthesizing unit 211i, a focus area setting unit 211j, and an evaluation value computing unit 211k.

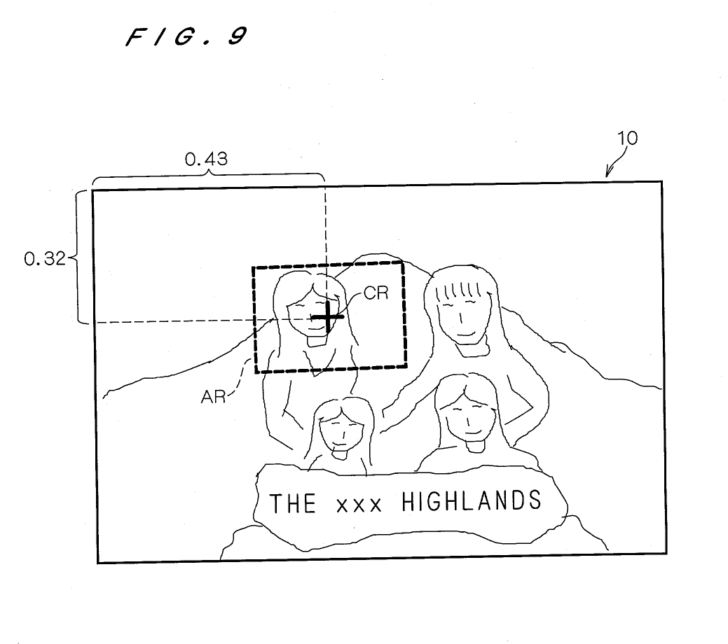

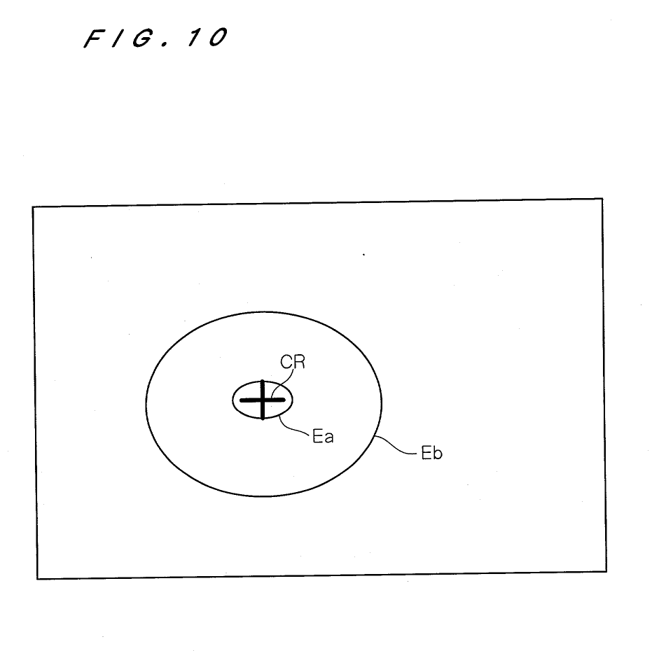

The cursor generating unit 211f reads cursor data for generating the AF cursor CR shown in FIG. 9 on the LCD 10 from a flash ROM 211b and transfers the cursor data to the cursor display position control unit 211g. The AF cursor CR has a cross shape and a size of 16×16 pixels on the LCD 10.

The cursor display position control unit 211g changes the display position of the AF cursor CR on the LCD 10 on the basis of the operation entered to the operating unit 250 by the operator. Consequently, the AF cursor CR working as a pointer moves on the LCD 10 in accordance with the operation input by the operator. The cursor display position control unit 211g switches whether the AF cursor CR is displayed on the LCD 10 or not.

The resolution converting unit 211h generates an image obtained by reducing the image data obtained by the CCD 303 to ¼, and transfers the reduced image to the image synthesizing unit 211i.

The image synthesizing unit 211i synthesizes an image inputted from the resolution converting unit 211h and the image of the AF cursor inputted from the cursor display position control unit 211g and transmits the composite image to the VRAM 210. By the synthesizing operation, the size of the AF cursor CR on the LCD 10 is unchanged irrespective of a reduction ratio of the resolution converting unit 211h.

The focus area setting unit 211j sets an AF area AR (see FIG. 9) used for focusing, which corresponds to the position of the AF cursor CR on the screen of the LCD 10. The AF area AR has a size of, for example, 200×80 pixels.

The evaluation value computing unit 211k performs an evaluation value computing operation for performing AF of a contrast method when the shutter button 8 is touched (S1). In this case, with respect to captured image data corresponding to the AF area AR, an evaluation value as a sum of absolute values of differences between neighboring pixels is computed. The lens is driven and the lens position in which the evaluation value is the largest is determined as a focus position. Consequently, the zoom lens 301 is driven to the AF area AR corresponding to the focus position to achieve focus, so that a focus can be achieved on a main subject or the like.

The digital camera 1 also has the image pickup mode of setting the AF area AR in a predetermined position in the LCD 10, concretely, in the center portion of the screen without designating the AF position by the AF cursor CR.

Regarding AE

AE based on weighted metering on the position of the AF cursor CR in the LCD 10 screen as a center is performed. In other words, the AF cursor CR also functions as the AE cursor corresponding to the photometric point.

In the photometry, as shown in FIG. 10, ellipses Ea and Eb functioning as photometric regions are set around the AF cursor CR as a center and, by designating a weighting factor of 8 to the inside of the ellipse Ea and designating a weighting factor of 2 to the area extending from the ellipse Ea to the ellipse Eb, photometric computation on the image data obtained by the CCD 303 is executed. It enables proper photometry on the main subject to be performed.

Recording of Image Data

Image data captured by the CCD 303 is recorded on the memory card 9 functioning as a nonvolatile memory and its recording format will be described later.

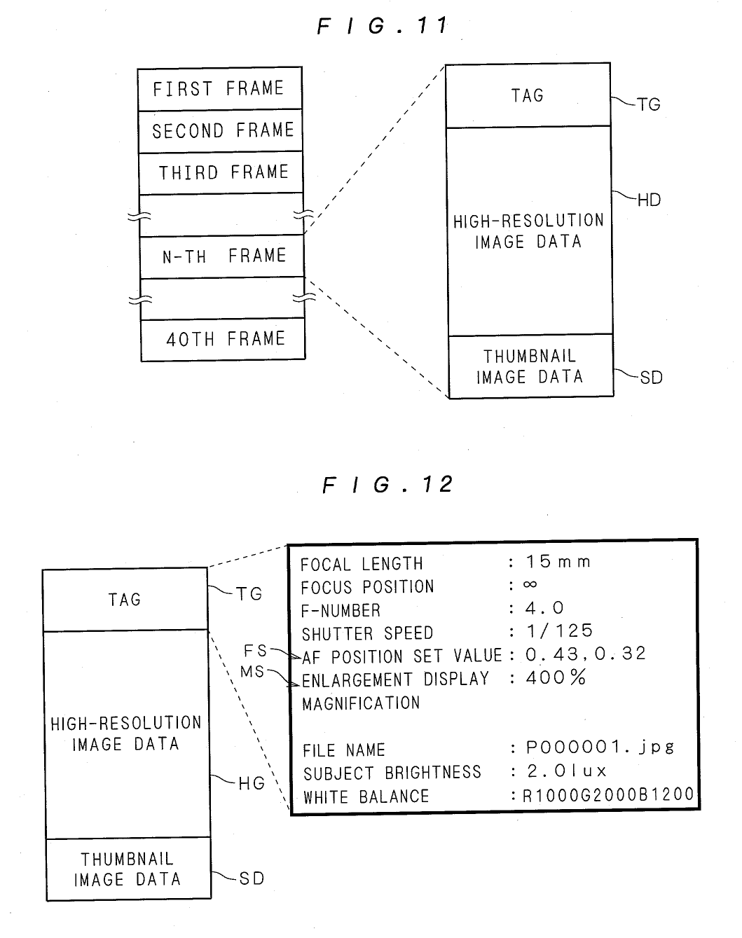

FIG. 11 is a diagram showing a data arrangement of the memory card 9. The memory card 9 functions as a recording medium for recording captured image data. As shown in FIG. 11, frames of images recorded by the digital camera 1 are sequentially arranged and stored in the memory card 9. In each frame, tag information TG, high-resolution image data HD (1600×1200 pixels) compressed by the Jpeg method, and thumbnail image data SD (80×60 pixels) for displaying a thumbnail image are recorded.

FIG. 12 is a diagram showing the contents of the tag information TG.

In the tag information TG, focal length and the like is recorded, and an AF position set value FS and an enlarging display magnification MS are recorded in association with image data.

The AF position set value FS indicates a coordinate value of the center of the AF cursor CR when each of the vertical and horizontal lengths of a whole image is 1, and is a numerical value from 0 to 1. For example, in the position of the AF cursor CR shown in FIG. 9, “0.43, 0.32” are set as AF position set values. Since the AF position is recorded at a ratio to an image, even in the case where images are captured by digital cameras having different steps of moving the AF cursor, different numbers of pixels of an image displayed, or different numbers of pixels of image pickup, the information of the AF position can be easily used.

The enlarging display magnification MS is set to, for example, 400% at the time of enlarging a captured image. In the digital camera 1, for example, by displaying a setting screen as shown in FIG. 13 onto the LCD 10. By operating the crossed switch 230, magnifications of 100%, 200%, 400% and 800% can be selected.

Image Capturing Operation of Digital Camera 1

The operation in the image pickup mode in the digital camera 1 will be described later. The operation is executed by the overall control unit 211.

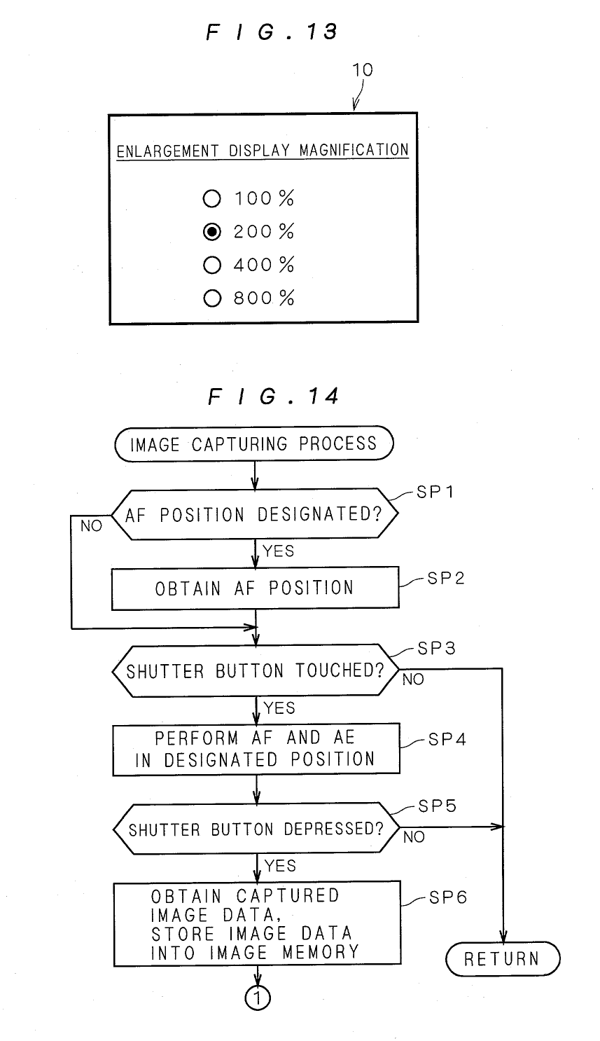

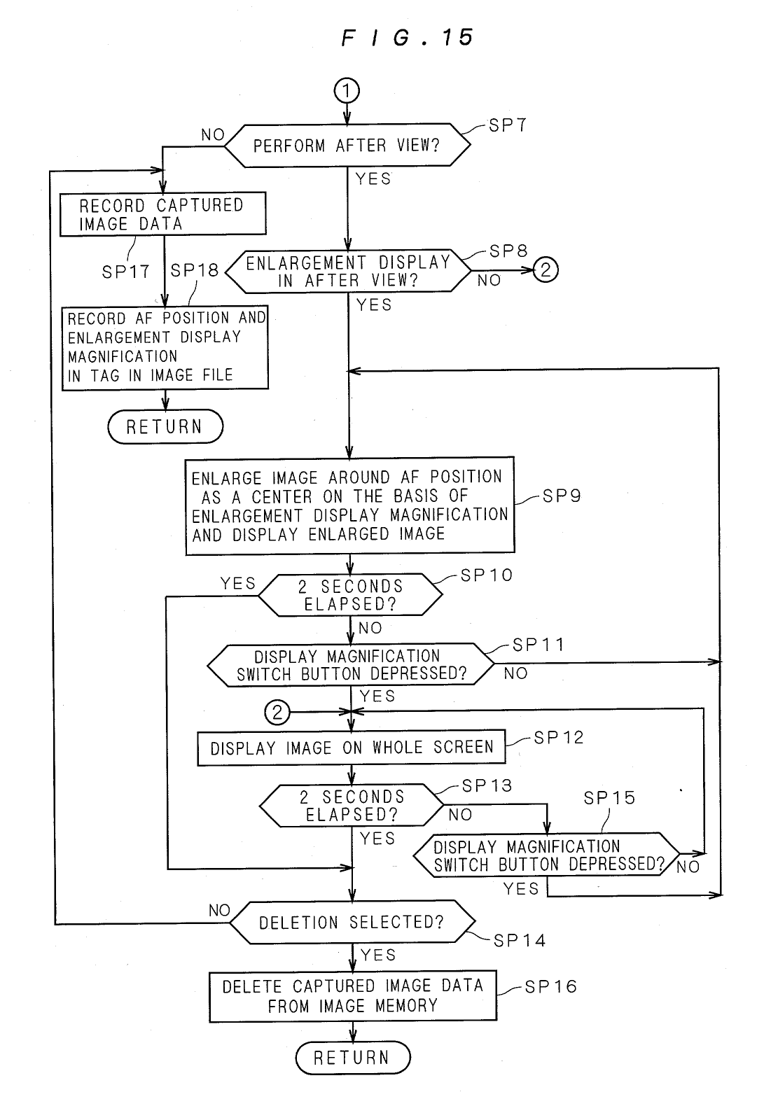

FIGS. 14 and 15 are flowcharts for describing the operation in the image pickup mode of the digital camera 1.

In step SP1, whether the AF position is designated by the AF cursor CR or not is determined. Concretely, whether the AF cursor button 225 is depressed or not by the operator is determined. If YES, the program advances to step SP2. If NO, the program advances to step SP3.

In step SP2, the AF position (designated position) of the subject designated by the AF cursor CR moved on the LCD 10 by the operation of the operator is obtained.

In step SP3, whether the shutter button 8 is touched (S1) by the operator or not is determined. In the case where the shutter button 8 is touched, the program advances to step SP4.

In step SP4, AF and AE are executed in the designated position. The designated position is the AF position obtained in step SP2 in the image pickup mode in which the AF position is designated by the AF cursor CR. In the other image pickup modes, the designated position is the center of the screen.

In step SP5, whether the shutter button 8 is fully depressed (S2) or not by the operator is determined. If YES, the program advances to step SP6.

In step SP6, image data is captured by the CCD 303 and stored into the image memory 209.

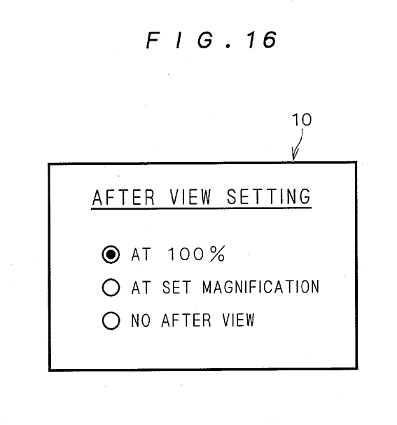

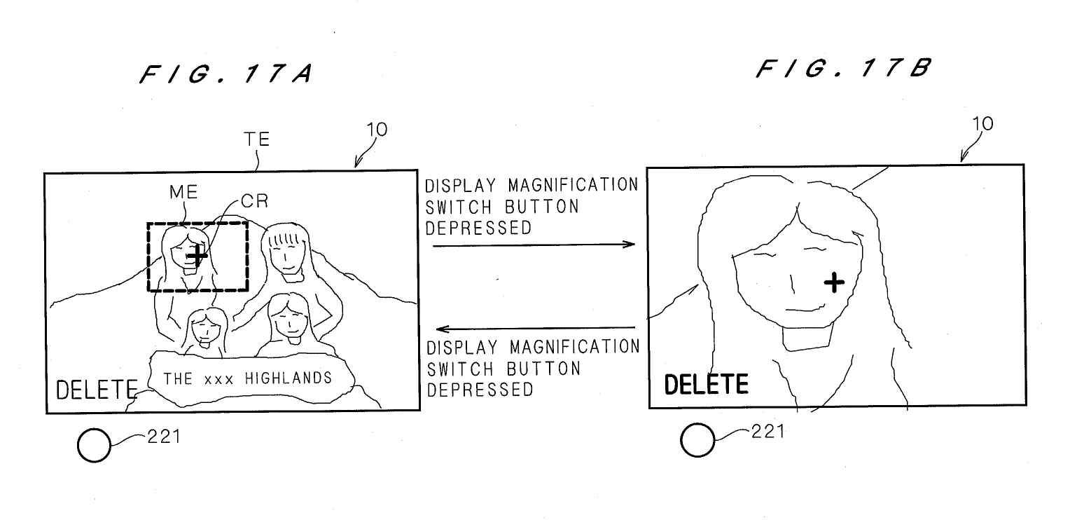

In step SP7, whether an after view is performed or not is determined. Specifically, as shown in FIG. 16, in an after view setting screen displayed on the LCD 10, when a setting of after view, that is, a setting other than “no after view” is selected in advance, it is determined that an after view is performed. In the case of performing an after view, the program advances to step SP8. If NO, the program advances to step SP17.

In step SP8, whether an image is enlargedly displayed in the after view or not is determined. Concretely, in the after view setting screen (FIG. 16), whether “perform after view at set magnification” is selected or not is determined. In the case of enlargedly displaying an image, the program advances to step SP9. If NO, the program advances to step SP12.

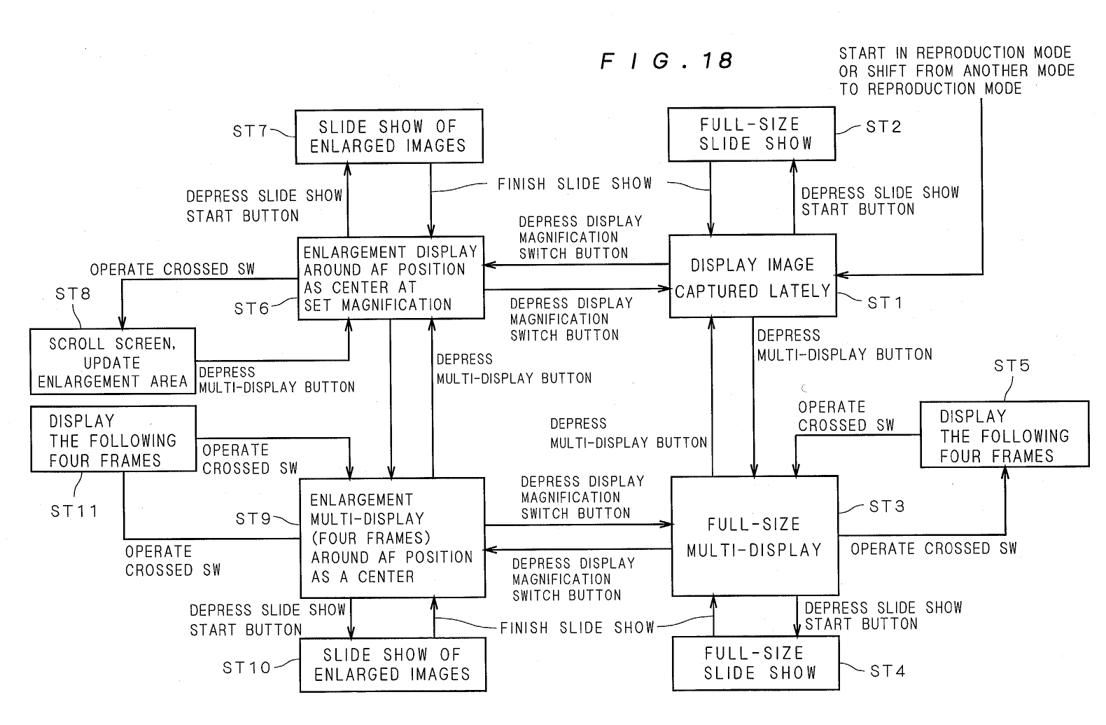

In step SP9, on the basis of an enlarging display magnification which is preset on the enlarging display magnification setting screen (FIG. 13) (hereinafter, simply referred to as “set magnification”), an image is enlarged around the AF position as a center and the enlarged image is displayed. Specifically, immediately after recording image data is obtained by the CCD 303 in step SP6, a partial image of the image data for recording is enlarged and the enlarged image is displayed. Concretely, as shown in FIG. 17A, an enlarged area ME is set around the AF cursor CR as a center, and a partial image corresponding to the enlarged area ME is enlarged and displayed on the LCD 10 as shown in FIG. 17B. When the AF position is not designated by the AF cursor CR, an image is enlarged at the set magnification around the center of a whole image TE shown in FIG. 17A as a center.

In step SP10, whether two seconds have elapsed or not since the after view started is determined. In the case where two seconds have elapsed, the program advances to step SP14. In the case where two seconds have not elapsed yet, the program advances to step SP11.

In step SP11, whether the display magnification switch button 224 is depressed by the operator or not is determined. If YES, the program advances to step SP12. If NO, the program returns to step SP9.

In step SP12, the captured image which is enlarged and displayed is reduced to 100% and the resultant image is displayed on the whole screen on the LCD 10. Concretely, a process of displaying the whole image TE on the whole screen as shown in FIG. 17A from the enlarged display shown in FIG. 17B is performed.

In step SP13, whether or not two seconds have elapsed since displaying of the image on the whole screen was started in step SP12 is determined. If two seconds have elapsed, the program advances to step SP14. If two seconds have not elapsed yet, the program advances to step SP15.

In step SP14, whether deletion of the captured image is selected or not is determined. Concretely, it is determined whether the delete button 221 is depressed or not in the after view is determined. In the case where deletion is selected, the program advances to step SP16. If deletion is not selected, the program advances to step SP17.

In step SP15, whether the display magnification switch button 224 is depressed or not by the operator is determined. When the display magnification switch button 224 is depressed, the program returns to step SP9 and enlarging display is performed again. If the display magnification switch button 224 is not depressed, the program returns to step SP12 and display on the full screen, that is, 100% display is continued.

In step SP16, the captured image data stored in step SP5 is deleted from the image memory 209.

In step SP17, the captured image data stored in the image memory 209 in step SP5 is recorded onto the memory card 9.

In step SP18, an AF position set value FS of the subject designated by the AF cursor CR and an enlarging display magnification MS selected on the enlarging display magnification setting screen (FIG. 13) are recorded in the tag TG (see FIG. 12) of an image file of the memory card 9.

By the image pickup operation of the digital camera 1, information of the AF position and the enlarging display magnification (hereinafter, referred to as “information of position and magnification”) is recorded on the memory card 9. Use of the information of the position and magnification thus recorded will be described with respect to each of the digital camera 1 and a personal computer.

Use of Position and Magnification in Digital Camera 1

The digital camera 1 can use the information of position and magnification recorded on the memory card 9 in a reproduction mode.

FIG. 18 is a status transition diagram showing the operation in the reproduction mode of the digital camera 1.

In status ST1, a recording image captured latest is displayed in full size on the LCD 10. In this case, the whole image TE shown in FIG. 17A is displayed on the whole screen of the LCD 10. When the slide show start button 222 is depressed, the digital camera 1 moves to status ST2. When the multi-display button 223 is depressed, the digital camera 1 moves to status ST3. When the display magnification switch button 24 is depressed, the digital camera 1 moves to status ST6.

In status ST2, a full-size slide show is performed. Specifically, a plurality of images stored in the memory card 9 are displayed one frame by one on the LCD 10. After the slide show is finished, that is, after the final frame is displayed, the digital camera 1 returns to the status ST1.

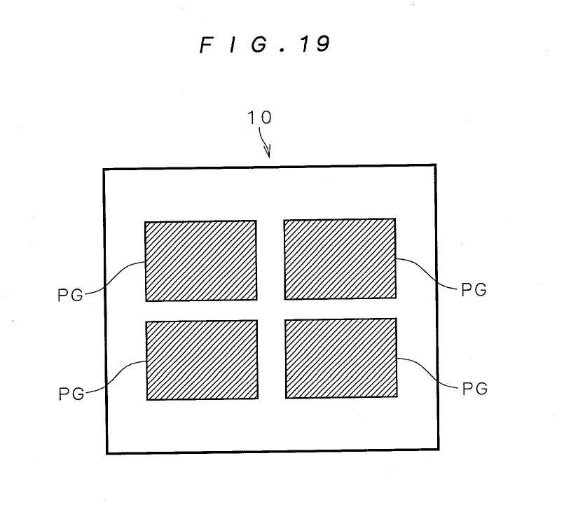

In status ST3, multi-display is performed on the LCD 10. In this example, as shown in FIG. 19, four captured images are simultaneously displayed in four image display areas PG. In each image display area PG, the whole image TE shown in FIG. 17A is reduced and displayed.

When the slide show start button 222 is depressed in the status ST3, the program shifts to status ST4. When the crossed switch 230 is operated, the program move to status ST5. When the display magnification switch button 224 is depressed, the program advances to status ST9.

In the status ST4, the slide show is performed in full-size multi-display. Different from the status ST2, recorded images are updated and displayed every four frames in the multi-display shown in FIG. 19. After the slide show is finished, the program returns to the status ST3.

In the status ST5, in response to the operation of the crossed switch 230 by the operator, the following four frames are displayed on the LCD 10. Concretely, by depression of the button 231, four frames preceding to the four frames being displayed are displayed. By depression of the button 232, four frames subsequent to the four frames being displayed are displayed.

In status ST6, one image is enlarged at a set magnification around the AF position as a center and the enlarged image is displayed on the LCD 10. Concretely, on the basis of the AF position set value FS and the enlarging display magnification MS recorded on the memory card 9, the enlarged area ME (see FIG. 17A) which is a part of the whole image TE and includes the AF position is set. A partial image corresponding to the enlarged area ME is enlarged and displayed on the LCD 10 as shown in FIG. 17B.

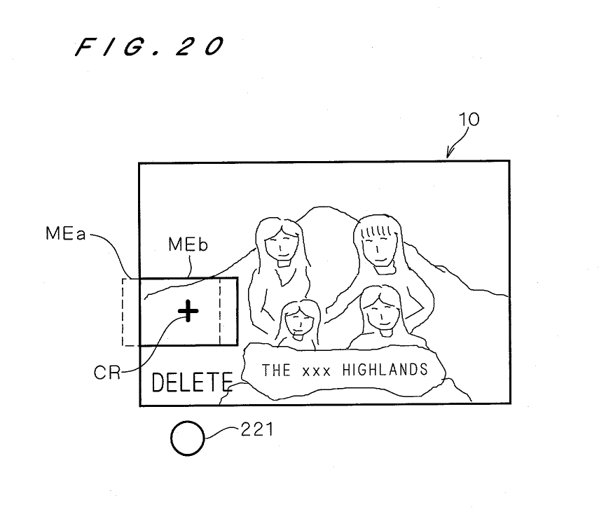

As shown in FIG. 20, when the position of the AF cursor CR is in a peripheral part in the image, an image is enlarged around the AF position CR as a center, and an area MEa lies off the whole image TE, an enlarged area MEb of which end is adjusted to an end of the whole image TE is set, and the image in the enlarged area MEb is displayed. In such a manner, at the time of enlarging display, a part having no image is not displayed, and an image can be properly displayed.

In status ST6, when the AF cursor button 225 is not depressed and the AF position is not designated at the time of shooting, the image is enlarged at the set magnification by enlarging the center position of the recorded image as a center.

In status ST6, when the slide show start button 222 is depressed, the program advances to status ST7. When the crossed switch 230 is operated, the program advances to status ST8. When the multi-display button 223 is depressed, the program advances to status ST9.

When the display magnification switch button 224 is depressed, the program shifts to status ST1. In such a manner, in status ST6 where the image is enlarged and displayed, in response to an operation on the display magnification switch button 224, enlarging display is canceled and the program shifts to status ST1 in which the whole image TE is displayed on the LCD 10. Consequently, the enlarging display magnification can be easily switched, and convenience of the digital camera 1 is improved.

In the status ST7, a slide show of enlarged images is performed. Specifically, while sequentially switching a plurality of partial images based on plural image data stored in the memory card 9, the partial images are displayed on the LCD 10 at the enlarging display magnification around the AF cursor position as a center. When there is no AF position designation, the recording image is enlarged around its center position as a center. After the slide show is finished, the program returns to the status ST6.

In status ST8, in response to the operation on the crossed switch 230 by the operator, the screen enlarged and displayed is scrolled and the enlarged area is updated. Conceptually, according to the depression of any of the four buttons 231 to 234, the enlarging area ME shown in FIG. 17A is moved up, down, right or left, and a process of enlarging the partial image in the enlarging area ME and displaying the enlarged image is performed.

In the status ST9, on the basis of the set magnification, an image is enlarged around the AF position as a center and the enlarged image is displayed in the four image display areas PG shown in FIG. 19. Concretely, based on the AF position set value FS and the enlarging display magnification MS recorded on the memory card 9, the partial images each in the enlarging area ME set with respect to four image data are displayed so as to be in the four image display areas PG.

In status ST9, when the slide show start button 222 is depressed, the program shifts to status ST10. When the crossed switch 230 is operated, the program shifts to status ST11. When the multi-display button 223 is depressed, the program advances to status ST6. When the display magnification switch button 224 is depressed, the program goes to status ST3.

In status ST10, a slide show of enlarging display is performed. Different from status ST4, on the multi-display screen shown in FIG. 19, images enlarged and displayed in a manner similar to status ST9 every four frames are updated and displayed. After slide show is finished, the program returns to status ST9.

In status ST11, in a manner similar to status ST5, in response to an operation on the crossed switch 230 by the operator, the following four frames are displayed on the LCD 10.

By the reproducing operation of the digital camera 1, the position and magnification information recorded on the memory card at the time of the image pickup mode can be used, so that convenience is improved in reproduction of the recording image.

Use of Position and Magnification in Personal Computer

In a personal computer, in the reproducing operation which will be described in detail later, the position and magnification information recorded on the memory card 9 can be used. In the following, first, the configuration of the main portion of a personal computer will be briefly described.

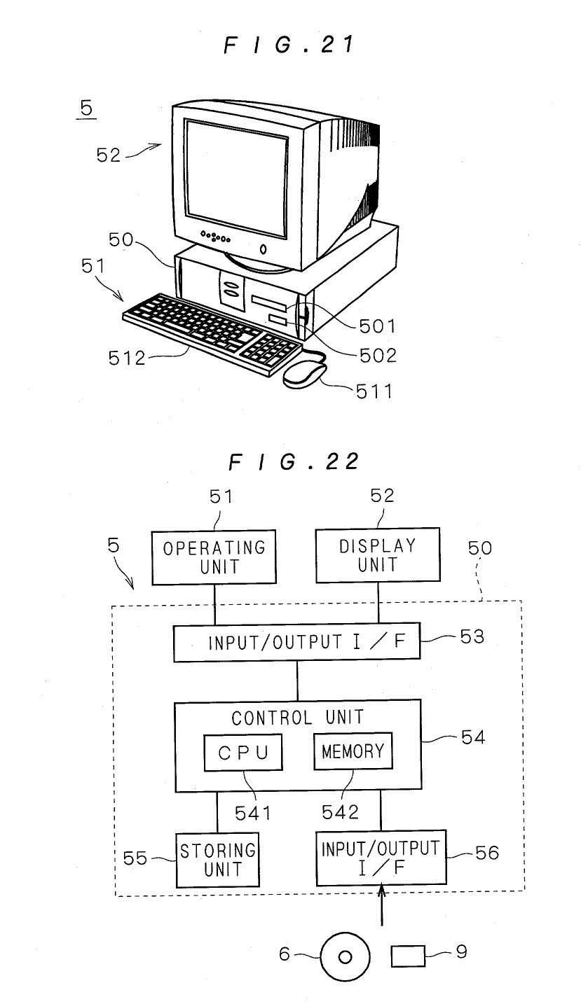

FIG. 21 is a schematic diagram showing the configuration of the main portion of a personal computer 5.

The personal computer 5 includes a processing unit 50 having a box shape, an operating unit 51 and a display unit 52, and functions as a processor.

The processing unit 50 has, in its front face, a drive 501 into which the recording medium 6 such as an optical disk can be loaded and a drive 502 into which the memory card 9 can be loaded.

The operating unit 51 has a mouse 511 and a keyboard 512 and accepts an input operation by the operator to the personal computer 5.

The display unit 52 takes the form of, for example, a CRT and functions as display means.

FIG. 22 is a functional block diagram of the personal computer 5.

The processing unit 50 has an input/output I/F 53 to be connected to the operating unit 51 and the display unit 52, and a control unit 54 to be electrically connected to the input/output I/F 53. The processing unit 50 further has a storing unit 55 to be electrically connected to the control unit 54, and an input/output I/F 56.

The input/output I/F 53 is an interface for controlling transmission/reception of data among the operating unit 51, the display unit 52 and the control unit 54.

The storing unit 55 is constructed as, for example, a hard disk and stores a program of reproducing a recorded image.

The input/output I/F 56 is an interface for inputting/outputting data to/from the recording media 6 and 9 via the drives 501 and 502.

The control unit 54 has a CPU 541 and a memory 542 and is a part for controlling the operation of the personal computer 5. By executing the reproducing program in the control unit 54, an image recorded on the memory card 9 is reproduced.

In the memory 542 of the control unit 54, program data recorded on the recording medium 9 can be stored via the input/output I/F 56. By the operation, the reproduction program stored in the recording medium 9 can be reflected in the operation of the personal computer 5.

The operation of reproducing image data recorded on the memory card 9 will be described later.

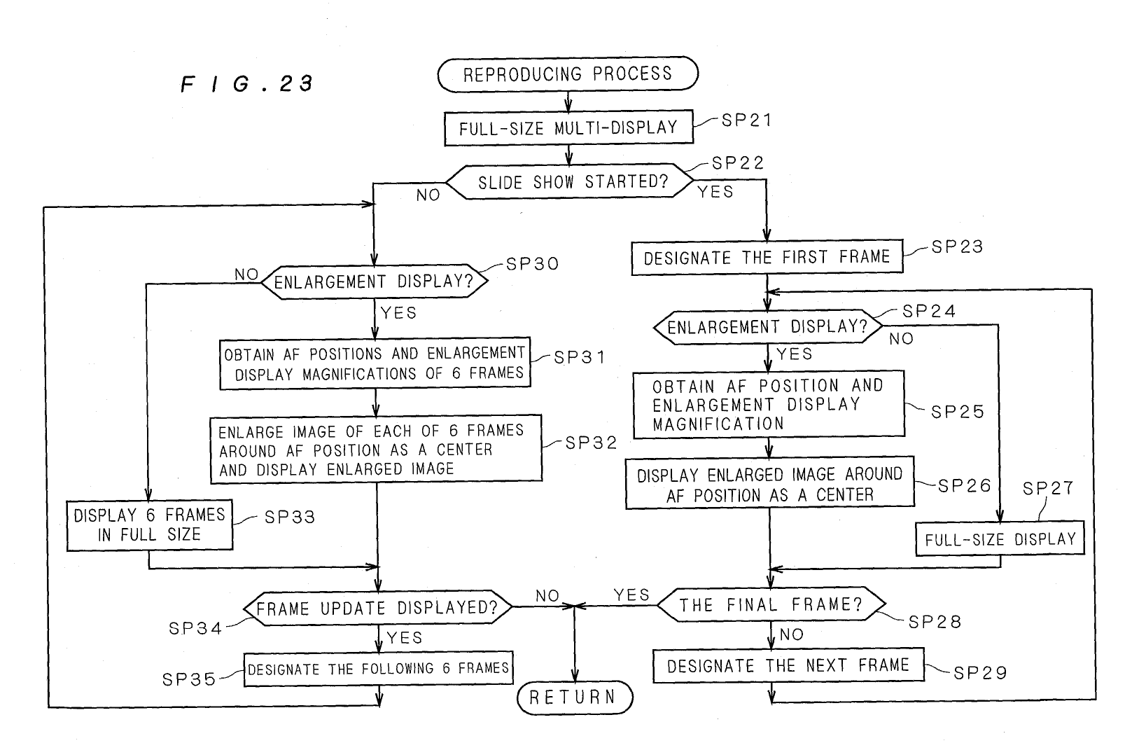

FIG. 23 is a flowchart for describing an operation of reproducing an image in the personal computer 5. The operation is executed by starting the reproduction program.

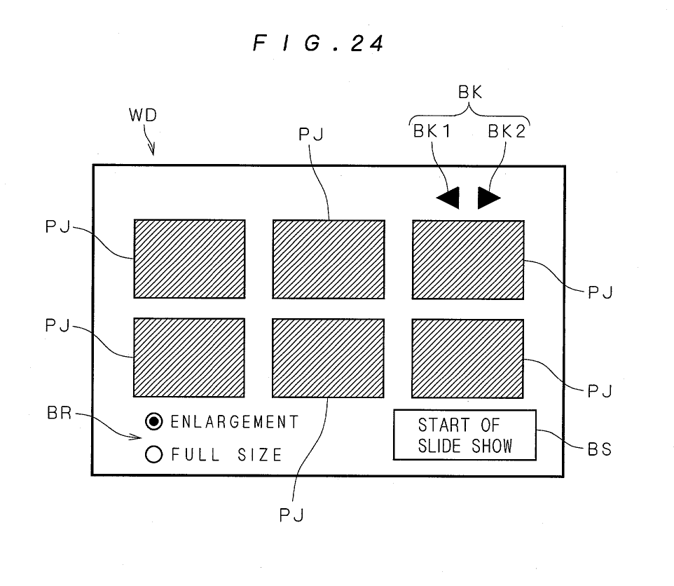

In step SP21, image data recorded on the memory card 9 is read and multi-display of full size is performed in a window screen WD (FIG. 24) displayed on the display unit 52. In each of six image display areas PJ, the whole image TE is displayed (see FIG. 17A).

In step SP22, whether the slide show is started or not is determined. Concretely, whether the slide show start button BS is clicked on the window screen WD shown in FIG. 24 by means of the operation of the mouse 511 by the operator is determined. In the case of starting the slide show, the program advances to step SP23. When the slide show is not started, the program advances to step SP30.

In step SP23, the first frame in the image data recorded on the memory card 9 is designated.

In step SP24, whether an image is enlargedly displayed or not is determined. Concretely, in the window screen WD, whether or not “enlarge” is designated by a radio button BR for selecting the size between enlargement and full size is determined. In the case of performing enlarging display, the program advances to step SP25. In the case where enlarging display is not performed, that is, “full size” is selected by the radio button BR, the program advances to step SP27.

In step SP25, the AF position set value FS and the enlarging display magnification MS associated with image data and recorded in the tag TG are obtained from the memory card 9.

In step SP26, on the basis of the set magnification, one image is enlarged around the AF position obtained in step SP25 as a center and the enlarged image is displayed. In the enlarging display, as shown in FIG. 17A, the enlargement area ME as a part of the whole image TE and including the AF position is set, and a partial image corresponding to the enlargement area ME is displayed in almost the full area of the window screen WD.

In step SP27, one image is displayed in full size on the window screen WD. In the full-size display, the whole image TE shown in FIG. 17A is displayed on the whole window screen WD.

In step SP28, whether the image being displayed is the final frame or not is determined. In the case where the image is not the final frame, the program advances to step P29.

In step SP29, the next frame is designated for an image being displayed. In such a manner, the slide show in which frames are sequentially sent and images are updated is performed.

In step SP30, in a manner similar to step SP24, whether an image is enlarged and displayed or not is determined. In the case of enlarging and displaying the image, the program advances to step SP31. If not, the program advances to step SP33.

In step SP31, the AF position set value FS and the enlarging display magnification MS of six frames recorded in the tag TG are obtained from the memory card 9.

In step SP32, each of images of six frames is enlarged around the AF position obtained in step SP31 as a center at the set magnification and the enlarged images of six frames are displayed in the six image display areas PJ in the window screen WD. In the enlargement display, a partial image in the enlargement area ME shown in FIG. 17A is displayed in each of the image display areas PJ.

In step SP33, the images of six frames are displayed as they are in the six image display areas PJ in the window screen WD. In the full-size display, the whole image TE is displayed in each image display area PJ.

In step SP34, whether the frame of the displayed image is updated or not is determined. To be specific, whether an update button BK in the window screen WD shown in FIG. 24 is clicked or not by the operation of the mouse 511 of the operator is determined. When an update button BK1 is depressed, a frame reversing process is performed. When an update button BK2 is depressed, a frame advancing process is performed. In the case of performing updating display, the program advances to step SP35.

In step SP35, six frames subsequent to six frames being displayed on the window screen WD are designated. Concretely, six frames preceding to the six frames being displayed are designated by depressing the update button BK1 and six frames subsequent to the six frames being displayed are designated by depressing the update button BK2.

As described above, since the position and magnification information recorded in the memory card can be used by the digital camera 1 in the reproducing operation of the personal computer 5, convenience is improved in reproduction of the recorded image.

Modifications

In the above described embodiment, the enlargement display position is designated by using the cursor (AF cursor CR) as a center. However, it is not indispensable to designate the enlargement display position by using the cursor as a center. The enlargement display position may be set by designating an area.

Information of the designation position in the above described embodiment is not always necessarily recorded on a memory card or the like but may be recorded on a nonvolatile memory such as a hard disk of a personal computer connected to a digital camera so that the information can be transmitted.

In the above described embodiment, it is not always necessary to record information of the AF position into the memory card, but the position information of a photometric point in the case of performing weighted photometry may be recorded. In this case as well, at the time of reproducing a recorded image, the enlargement display around the photometric point as a center can be performed and convenience is improved.

In the case of designating the position of a trimming area (editing area) for editing an image on the LCD, the positional information may be recorded. In this case as well, an effect similar to the above can be expected.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image sensor for capturing an image of a subject and generating image data;
a display for displaying an image based on said image data generated by said image sensor onto a screen;
a designating member for designating a specific position in said image displayed on said screen; and
a recorder for recording said image data and information of said specific position designated by said designating member so as to be associated with each other on a nonvolatile memory.

2. The image capturing apparatus according to claim 1, further comprising:
a display controller for enlarging an image in a predetermined area including said specific position designated by said designating member and displaying an enlarged image onto said display.

3. The image capturing apparatus according to claim 2, wherein
said display controller enlarges an image in an area having said specific position designated by said designating member as a center and displays an enlarged image on said display.

4. The image capturing apparatus according to claim 3, wherein
when said area includes an area other than an image, said display controller further sets an area for enlarging and displaying in an end portion of said image.

5. The image capturing apparatus according to claim 2, wherein
said recorder further records a display magnification of said predetermined area into said nonvolatile memory.

6. The image capturing apparatus according to claim 2, wherein
said display controller enlarges images in a plurality of predetermined areas based on plural image data and displays enlarged images onto said display while sequentially switching said images.

7. The image capturing apparatus according to claim 2, wherein
said display controller enlarges images in a plurality of predetermined areas based on plural image data and simultaneously displays enlarged images onto said display.

8. The image capturing apparatus according to claim 2, wherein
immediately after image data for recording is obtained by said image sensor, said display controller enlarges an image in said predetermined area on the basis of said image data for recording and displays an enlarged image onto said display.

9. The image capturing apparatus according to claim 2, further comprising:
a canceling member for canceling enlargement display on said display.

10. The image capturing apparatus according to claim 1, further comprising:
an image capturing optical system; and
an auto-focus controller for making said image capturing optical system achieve focus on said specific position designated by said designating member.

11. The image capturing apparatus according to claim 1, further comprising:
a photometric controller for performing photometric operation with respect to said specific position designated by said designating member.

12. The image capturing apparatus according to claim 1, wherein
said nonvolatile memory is a recording medium attachable/detachable to/from said image capturing apparatus.

13. An image reproducing apparatus capable of reproducing image data in a nonvolatile memory, which is recorded in association with information regarding a specific position in said image data, said image reproducing apparatus comprising:
a first reader for reading said image data recorded on said nonvolatile memory;
a second reader for reading positional information regarding said specific position recorded on said nonvolatile memory;
a display for displaying an image based on said image data read by said first reader onto a screen; and
a display controller for enlarging an image in a predetermined area including said specific position in said image and displaying an enlarged image onto said display on the basis of said positional information read by said second reader.

14. The image reproducing apparatus according to claim 13, wherein
said positional information is information regarding a focus position of corresponding image data.

15. The image reproducing apparatus according to claim 13, wherein
said positional information is information regarding a photometric position in corresponding image data.

16. The image reproducing apparatus according to claim 13, wherein
said nonvolatile memory further records magnification information regarding display magnification of an image,
said image reproducing apparatus further comprises a third reader for reading said magnification information, and
said display controller enlarges an image in said predetermined area on the basis of said magnification information read by said third reader and displays an enlarged image onto said display.

17. A program product on which a program that can be read by an image processing apparatus is recorded, wherein
when said program is installed onto said image processing apparatus, said program makes said image processing apparatus to execute the steps of:
reading image data recorded on a nonvolatile memory;
reading information regarding a specific position in said image data, which is recorded on said nonvolatile memory so as to be associated with said image data; and
enlarging an image based on image data in a predetermined area including said specific position on the basis of read information regarding said specific position and displaying an enlarged image onto a display.
